(19) United States
(12) Patent Application Publication
(10) Pub. No.: US 2014/0085070 A1
(43) Pub. Date: Mar. 27, 2014

(54) Systems and Methods for Monitoring the Orientation, Tensioning, and Installation of a Child Safety Restraint

(71) Applicant: Cars-N-Kids LLC, (US)

(72) Inventor: Gregory B. Schoenberg, St. Louis, MO (US)

(21) Appl. No.: 13/648,949

(22) Filed: Oct. 10, 2012

Related U.S. Application Data
(63) Continuation-in-part of application No. 13/370,021, filed on Feb. 9, 2012.
Application No. 13/370,021 is a continuation-in-part of application No. 12/335,421, filed on Dec. 15, 2008, now Pat. No. 8,212,665.
(60) Provisional application No. 61/013,929, filed on Dec. 14, 2007.
(60) Provisional application No. 61/538,647, filed on Sep. 23, 2011.
(60) Provisional application No. 61/441,199, filed on Feb. 9, 2011.
(60) Provisional application No. 61/504,113, filed on Jul. 1, 2011.

(51) Int. Cl. B60Q 1/00; B60R 22/10

(52) U.S. Cl. CPC B60Q 1/00; B60R 22/105
USPC 340/457.1

(57) ABSTRACT

Child seat installation monitoring system and methods that monitor child seat orientation, belt tension, air temperature, and other factors, and provide notifications and alerts to a user of conditions via indications, a mobile device such as a smart phone, an in-car notification system, and other systems.

### CROSS REFERENCE TO RELATED APPLICATION(S)

This application is a Continuation-in-Part of U.S. Utility application Ser. No. 13/370,021 filed Feb. 2, 2012 which is a Continuation-in-Part (CIP) of U.S. Utility patent application Ser. No. 12/335,421, now U.S. Pat. No. 8,212,665, which in turn claims the benefit of U.S. Provisional Application Ser. No. 61/013,929 filed Dec. 14, 2007, and also claims the benefit of U.S. Provisional Application Ser. No. 61/441,199 filed Feb. 9, 2011, U.S. Provisional Application Ser. No. 61/504,113 filed Jul. 1, 2011, and U.S. Provisional Application Ser. No. 61/538,647 filed Sep. 23, 2011. This application also claims benefit of U.S. Provisional Patent Application 61/545,354 filed Oct. 10, 2011 and U.S. Provisional Patent Application 61/678,508 filed Aug. 1, 2012. The entire disclosure of all of these documents is herein incorporated by reference.

### BACKGROUND

1. Field of the Invention

This disclosure is related to the field of child safety devices. Specifically, to devices which can detect the orientation and proper installation of a child seat in a vehicle.

2. Description of the Related Art

The majority of vehicular child safety restraint seats, popularly called “child seats,” are not properly installed, leaving children at an increased risk of injury. Although child seat manufacturers and automobile companies provide detailed instructions on how to install child seats in vehicles, users routinely install the child seats at improper angles, with incorrect tension on the restraining belts between the seat and the vehicle, and/or with incorrect tension on the restraining belts between the seat and the child.

Some seats include a bubble or ball level to aid the user in installing the seat at the proper angle, but bubble levels work on just one plane of orientation, and the proper installation of a child seat can require that multiple planes or orientation be adjusted. For example, the forward-to-back angle of the child seat (“pitch”) and side-to-side angle of the child seat (“roll”) should be properly set. Bubble levels also cannot provide feedback on belt tension. Further, even where a child seat initially is installed properly the child seat may be jostled or shifted and tension may loosen over time.

Ordinary use of a family vehicle tends to dislodge the child seat from proper orientation and tension over time. The insertion and removal of cargo in the vehicle may bump the child seat, the child using the seat may move, or passengers in the vehicle may climb over and around the seat or use it for leverage in entering, existing, or moving about in the vehicle. In the fast-paced life of a modern family, users may not have time to assess the problem, to say nothing of correcting it, again placing the children at increased risk of injury. The existing bubble levels provide no means for notifying the user that the child seat orientation is unsafely out of alignment, or that the belt tension is too loose.

Further, in the fast-paced life of a family, children may be hastily buckled into their child seats, and the buckles may not latch properly. Also, older children often learn how to undo the safety restraints in the child seat, and may clandestinely unclasp or unbuckle themselves without the vehicle operator or passengers noticing. This again poses increased risk to the child.

### SUMMARY

The following is a summary of the invention which should provide to the reader a basic understanding of some aspects of the invention. This summary is not intended to identify critical components of the invention, nor in any way to delineate the scope of the invention. The sole purpose of this summary is to present in simplified language some aspects of the invention as a prelude to the more detailed description presented below.

Because of these and other problems in the art, described herein, among other things is a child seat orientation monitor comprising: a housing; an orientation detector within the housing; a force transducer within the housing; wherein force exerted on the housing is translated to the force transducer; wherein when the monitor is attached to a child seat installed in a vehicle, the orientation detector determines the orientation of the child seat and the force transducer determines the tension of a belt attaching the child seat to the vehicle.

In an embodiment, the orientation detector is a three-axis accelerometer.

In an embodiment, the monitor further comprises: a wireless transmitter within the housing transmitting data about the orientation and the tension.

In an embodiment, a mobile device receives and displays the data.

In an embodiment, the mobile device is a mobile phone.

In an embodiment, the device is a tablet computer.

In an embodiment, a vehicle computer system receives and displays the data.

In an embodiment, the wireless transmitter uses a BlueTooth protocol.

In an embodiment, the monitor further comprises: a temperature sensor within the housing determining the air temperature near the child seat.

Also described herein, among other things, is a system for providing notifications about the installation of a child seat in a vehicle, the system comprising: an orientation detector attached to a child seat for detecting the orientation of the child seat in a vehicle; a force transducer attached to the child seat for detecting the tension of a belt attaching the child seat to the vehicle; a wireless transmitter transmitting data about the orientation and the tension; a wireless receiver receiving the data; and a display for conveying the data transmitted by the wireless transmitter and received by the wireless receiver to a user.

In an embodiment, the wireless transmitter uses a BlueTooth protocol.

In an embodiment, the orientation detector is a three-axis accelerometer.

In an embodiment, the display is a mobile phone.

In an embodiment, the display is a vehicle computer system.

In an embodiment, the system further comprises: a temperature sensor detecting the air temperature near the child seat; wherein the wireless transmitter transmits data about the air temperature, the wireless receiver receives the data, and the display conveys the data to a user.

Also described herein, among other things, is a method for providing notifications about the installation of a child seat in a vehicle, the method comprising: providing a child seat orientation monitor including: an orientation detector; a force transducer; a wireless transmitter; providing a display separate from the orientation monitor and configured to receive transmissions from the wireless transmitter; providing a child seat; providing a vehicle; installing the orientation monitor in the child seat; installing the child seat in the vehicle with a belt; the orientation monitor detecting the orientation of the child seat in the vehicle with the orientation detector; the orientation monitor detecting the tension of the belt with the force transducer; the orientation monitor transmitting data about the orientation and the tension to the display with the wireless transmitter; the display providing a notification of the orientation and the tension to a user.

In an embodiment, the orientation detector is a three-axis accelerometer.

In an embodiment, the display is a mobile phone.

In an embodiment, the display is a vehicle computer system.

In an embodiment, the method further comprises: in the providing, the child seat orientation monitor further comprising a temperature sensor; the orientation monitor detecting the air temperature near the child seat with the temperature sensor; the orientation monitor transmitting data about the air temperature to the display with the wireless transmitter; the display providing a notification of the air temperature to a user.

### BRIEF DESCRIPTION OF THE DRAWINGS

FIG. 1 shows an embodiment of a child seat orientation monitor in a child seat.

FIG. 2 shows an exploded view of an embodiment of a child seat orientation monitor.

FIGS. 3, 4, 5, 6, and 7 show embodiments of screenshots which can be presented to a user on a device such as a smart phone which provide indications of features and show alterations to the child seat orientation.

FIGS. 8A, 8B, 8C, 8D, 8E and 8F and 9 show circuit diagrams of embodiments of a child seat orientation monitor.

### DESCRIPTION OF PREFERRED EMBODIMENTS

Although the present invention is described with particular reference to the accompanying drawings, it is to be understood at the outset that it is contemplated that the present invention may vary in specific detail from that illustrated and described herein while still achieving the desirable characteristics and features of the present invention. Accordingly, the description that follows is intended to be understood as a broad enabling disclosure directed to persons skilled in the applicable arts, and is not to be understood as being restrictive.

Generally, the systems and methods described herein include three major component systems which may be arranged and implemented in a variety of configurations. First, there is a system (807) for determining the orientation of a child seat (103) installed in vehicle. Second, there is a system (809) for determining the tension on a belt (109) used to affix the child seat (103) to the vehicle, or to restrain the child in the child seat (103). Third, there is a system (811) for notifying the user regarding the orientation of the child seat (103) and/or the tension of a belt (109). These components are generally included in a child seat orientation monitor (201).

It is generally contemplated that the child seat orientation monitor (201) described herein is a device separate from the child seat (103) itself and which is attached to the child seat (103) by the consumer as part of the general installation of the child set (103) in a vehicle. However, it is also specifically contemplated that one of more component systems or one or more elements of a component system may be integrated into a child seat (103) or into a vehicle. By way of example and not limitation, in an embodiment a belt (109) tension sensor may be integrated into the child seat (103).

The systems and methods discussed herein are generally designed to operate in conjunction with the use of a child seat (103) in a vehicle. This child seat (103) may be of any type, and for any aged child and may be, without limitation, forward facing, rearward facing, convertible, or a booster seat. The monitor (201) may be used on child seats (103) which are designed to be left in the vehicle with the child getting out of the seat to leave the vehicle, may be used on child seats (103) which are removed with the child when the child leaves the vehicle, or may be used on child seats (103) which utilize a car adapter where a portion of the child seat (103) is removed with the child, but a connector or similar structure is designed to remain in the vehicle.

The systems and methods discussed herein are generally designed to operate in conjunction with a motorized, wheeled passenger vehicle, but the systems and methods are suitable for use with other modes of transportation as well, including without limitation: rail travel, aircraft, spacecraft, watercraft, motorcycles, and unpowered means such as bicycles and shopping carts.

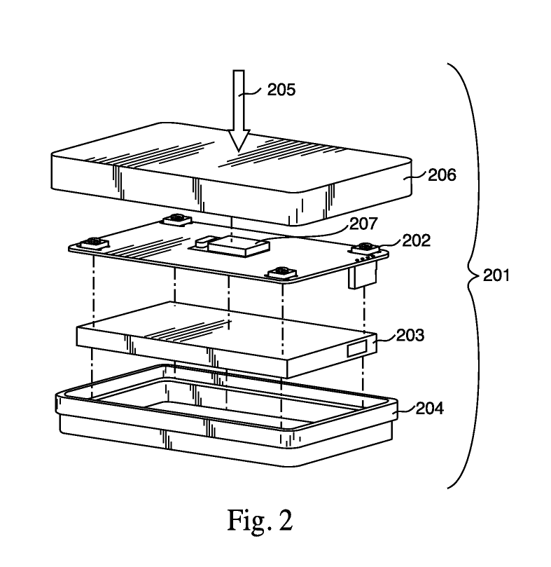

FIG. 2 depicts an exploded view of an embodiment of a child seat orientation monitor (201). The depicted embodiment includes a top housing (206), a bottom housing (204), a power source (203), and a circuit board (202). In the depicted embodiment, the circuit board (202) includes a system for determining orientation in the form of a three-axis accelerometer (807), though any means for determining the position of the child seat (103) may be used. The circuit board (202) also includes a system for determining belt tension in the form of a force tension sensor (809), sometimes also referred to as a force transducer. The circuit board (202) also includes a system for notifying the user in the form of a BlueTooth® wireless transmitter (811). These components are connected to a circuit board (202) and connect to a microprocessor (803), which is also connected to the circuit board (202), via supporting electronic components and circuitry. Generally, the microprocessor (803) controls and coordinates the components to operate the monitor.

In the depicted embodiment, a three-axis accelerometer (807) is used to determine orientation of the child seat (103). This may be done by, for example, attaching the accelerometer (807) to the child seat (103) in a fixed position relative to the child seat (103) such as that changes in the angular orientation of the child seat (103) necessarily result in proportional or equal changes in the angular orientation of the accelerometer (807), thereby allowing the accelerometer (807) to measure changes in the angular orientation of child seat (103) by detecting changes in the angular orientation of itself. However, in an alternative embodiment, the system for detecting orientation need not itself by attached to the child seat in this fashion. In an embodiment, the orientation detection system may not itself experience changes in angular orientation, or only a component subsystem of the orientation detection system may experience changes in angular orientation.

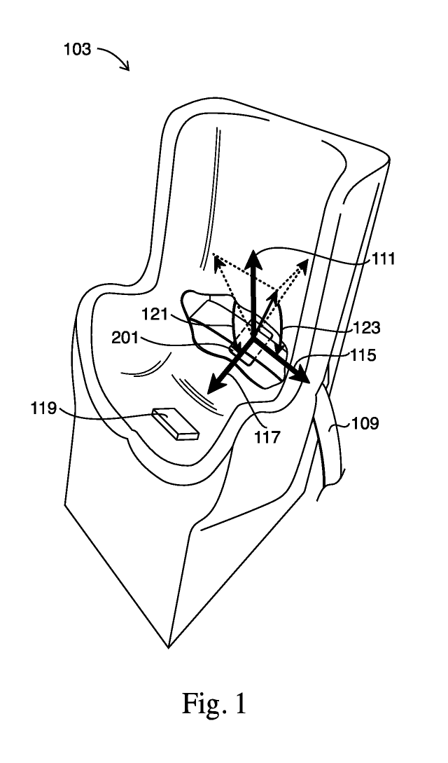

The assembled monitor (201) is preferably a little larger than a credit card. As depicted in FIG. 1, the monitor may be placed within the structure of a child seat (103) at a location where the restraining belt (109) used to attach the child seat (103) to the vehicle interfaces with the child seat (103). The monitor (201) generally is situated such that it is between the belt (109) and a surface of the child seat (103) on which the belt (109) exerts downward pressure (205) when the child seat (103) is installed in a vehicle causing tension on the belt (109) to compress the monitor (201). This tension is translated through the top housing (206) to a force transducer (809) via a pressure switch (207). It is preferred that the device (201) be in direct contact with the belt (109).

In the typical child seat (103) installation, a belt (109) is used to attach the child seat (103) to the vehicle. The child seat (103) is placed on top of a passenger seat in the vehicle, such as a captain's chair or bench seat, and the child seat (103) includes openings on each lateral side which accept a belt (109). A restraining belt (109) with a clasp, or other system for attaching to the car, at either end is laced through the lateral openings in the child seat (103) and the clasps are attached to the vehicle. This may be done using seat belts integrated into the vehicle, such as a two-point lap belt or three-point lap/shoulder belt which is threaded through the openings and attached to the vehicle using the same anchor points that an adult passenger would use to engage the seat belts.

However, and as elsewhere discussed herein, many child seats (103) include special belts designed for use with the child seat (103), and these specialized belts (109) are sometimes preferred over the use of vehicular seat belts. These special belts (109) may also be laced through such lateral openings and attached either to the seat belt anchors built into the vehicle, or to specialized anchors designed for use with child seats (103), often referred to as the LATCH system in the United States. The main portion of the belt (109) then generally lays flat against a surface of the child seat (103), exerting downward pressure pulling the child seat (103) toward the vehicle passenger seat. The belt (109) is tightened, and belt (109) tension accordingly increased, by pulling on straps attached to tension adjustors. The installer often kneels on the child seat (103) to press it firmly into the vehicle passenger seat while tightening the belt (109). The result is a snug fit with little slack in the belt (109).

By placing the monitor (201) between the belt (109) and the flat surface of the child seat on which the belt (109) exerts downward force to hold the child seat (103) in place, the monitor (201) is situated to receive tension on the belt (109). The compressive pressure (205) exerted by the belt (109) on the monitor (201) causes inward distortion of the top housing (206) toward the pressure switch (207). When the distorted top housing (206) contacts the pressure switch (207), it in turn translates downward pressure (205) from the belt (109) tension into pressure on the pressure switch (207), causing the pressure switch (207) to depress. A force transducer (809) detects the amount of depression in the pressure switch (207), and converts this amount into a signal which is detectable by the microprocessor (803). The microprocessor (803) or another component of the monitor (201), may convert this signal into a measure of belt (109) tension. In an embodiment, this conversion is not performed by the monitor (201), but rather another device or component of the system, such as a mobile device application or in-car computer system application. Any suitable means for performing the conversion is contemplated, including without limitation the use of circuitry or software functions executed by the force transducer (809), microprocessor (803), another component of the monitor (201), or another component system.

The precise placement of the monitor (201) in the child seat (103) will necessarily vary from child seat (103) to child seat (103), depending on, among other things, how the child seat (103) is constructed and attached to the vehicle. The placement of the monitor (201) in the child seat (103) may also vary for a given child seat (103) depending on how the child seat (103) is to be attached to the vehicle. By way of example and not limitation, the monitor (201) may be placed differently depending on whether the child seat (103) is attached via a LATCH belt (109) or a vehicular seat belt (109). In an embodiment, the monitor (201) further comprises an adhesive system. This system may hold the monitor (109) in place between the belt (109) and child seat (103) during installation to make it easier to install the child seat (103) with the monitor (201). The adhesive system may include, without limitation, a chemical adhesive, a hook-and-loop system, or a coating or layer with a high coefficient of friction.

The present systems and methods are suitable for use with any type of belt (109). In the preferred child seat (103) installation, the child seat (103) is attached to the vehicle using a belt (109) provided with the child seat (103) and designed for this purpose. It is also preferred that the belt (109) be attached to metal anchors integrated into the vehicle and designed for accepting and securing belts for child seats (103). These anchors are commonly known as the LATCH System in the United States. The present systems and methods will also function with other installations, including but not limited to anchoring and tethering systems other than LATCH, and other types of belts, such as seat belts (109) integrated into the vehicle and laced through the child seat (103). The systems and methods function regardless of belt (109) type because, among other things, optimal belt tension is generally the same regardless of belt (109) type or installation method.

It should be noted that there are a number of configurations of belts (109) for attaching child seats (103) to vehicles and it is contemplated that the present systems and methods may be used to detect the tension on any such belts (109). In addition to the systems described above, other child seats (103) may have a belt (109) attached or integrated into the structure of the child seat (103) itself, rather than floating freely against a surface of the child seat (103). In such an embodiment, the present systems and methods may be implemented with different components. By way of example and not limitation, a spring tension detection system may be used with child seats (103) which are not held in place via lateral belt tension against a surface of the seat but where such belts (109) are a part of the child seat (103).

Child seats (103) also generally include an “overhead” belt (109) attached to the child seat (103) near the top rear of the child seat (103) headrest. This belt (109) is generally attached to the back of the vehicular passenger seat to which the child seat (103) is attached, generally using specialized anchors integrated into the vehicular passenger seat for this purpose. The systems and methods disclosed herein are also applicable to detecting the tension on such a belt (109), such as but not limited to by interposing a monitor (201) or other tension detection system between the belt (109) and a surface to which the belt tension applies pressure, or by integrating a tension detection system in whole or part into the child seat (103) or belt (109).

In an embodiment, a tension detection system may be integrated, in whole or part, into the child seat (103) itself, or into a belt (109). By way of example and not limitation, a belt (109) may itself include a system or method for detecting tension in the belt (109).

The monitor (201) also includes a system for detecting the child seat's (103) orientation. In the depicted embodiment, this means system includes a three-axis accelerometer (807). As depicted in FIG. 1, there are three axes of movement for the child seat (103) with respect to the car. The x-axis (115) of movement is the left-right axis from one lateral side of the vehicle to the other. Rotation of the child seat (103) around the x-axis (115) results in “pitch” (121) motion: change in the forward-to-back angle of the child seat (115) which moves the z-axis (111) of the child seat (103) too far toward the front or back of the vehicle. The y-axis (117) of movement is an anteroposterior axis from the front to the back of the vehicle. Rotation of the child seat (103) around the y-axis (117) results in “roll” (123) motion: change in the side-to-side angle of the child seat (103) which moves the z-axis (111) of the child seat (103) too far toward the left or right side of the vehicle. The z-axis (111) of motion is a dorsoventral axis from the top of the vehicle to the bottom. Rotation of the child seat (103) around the z-axis (111) results in no pitch or roll, but causes the child seat (103) to “slip;” that is, not to face directly forward (or backward, for a rear-facing child seat (103)) with respect to the passenger seat in which it is installed.

It should be noted that the orientation detection system will generally have three internal axes and these axes do not need to be aligned with those discussed above, as coordinates can be freely translated between coordinate systems. However, discussion of types of rotation of the child seat (103) relative to the vehicle in the above manner helps in understanding.

Generally, an accelerometer (807) detects angular orientation of the child seat (103), and converts that data into a signal which is detectable by the microprocessor (803). The microprocessor (803), or another component system, converts this signal into a measure of the angular orientation of the child seat (103) in each of the three axes of movement. Generally, an accelerometer (807) detects changes in pitch (121) and roll (123) of the child seat (103), or rotation of the child seat (103) about the y-axis (117) and x-axis (115). In an embodiment, an accelerometer (807) also detects slip, or rotation of the child seat (103) about the z-axis (111). The accelerometer (807) can simultaneously detect simultaneous rotation about multiple axes. By way of example and not limitation, the accelerometer (807) can simultaneously detect forward pitch (121) and left roll (123), where such pitch (121) and roll (123) occur simultaneously. Where motion occurs simultaneously in multiple axes, the accelerometer (807) can isolate motion along one axis and provide data on that motion alone.

The accelerometer (807) detects various motion of the child seat (203), and the monitor (201), or another component system, may use this motion data to determine whether the child seat (103) is properly installed. Any suitable means for carrying out this determination is contemplated, including without limitation the use of circuitry or software functions executed by the accelerometer (807), microprocessor (803), another component of the monitor (201), or another component system. Generally, it is preferred that the data from the accelerometer (807) is output via a signal to the microprocessor (803), which performs mathematical calculations to determine the orientation of the child seat (103). It is specifically contemplated that data may be collected, processed, transmitted, displayed, and/or otherwise processed by the systems and methods while the vehicle is stopped or motion.

In an embodiment, the device also includes a notification system. This system provides a user with assurance that the child seat (103) is properly installed, tensioned, and oriented, or a warning that the child seat (103) is not properly installed, tensioned, and/or oriented. However, depending on the particular functions included in the monitor (201), it may provide notification for other purposes as well. By way of example and not limitation, in an embodiment including a system for detecting whether the safety restraint harness holding the child in the child seat (103) is fully engaged, the notification system may be used to provide notification to the user that the safety restraint harness is properly (or improperly) engaged. Also by way of example and not limitation, in an embodiment having a temperature sensor (805), the notification system may be used to provide notification of temperature readings by the temperature sensor (805) and other information or data derived therefrom. In an embodiment, the notification system may be used to provide notification of whether the child is asleep or wake, whether the child is moving or still, whether the child is breathing, whether the child has or is attempting to evacuate the child seat (103), whether the child or child seat (103) are soiled, and duration of these and other conditions.

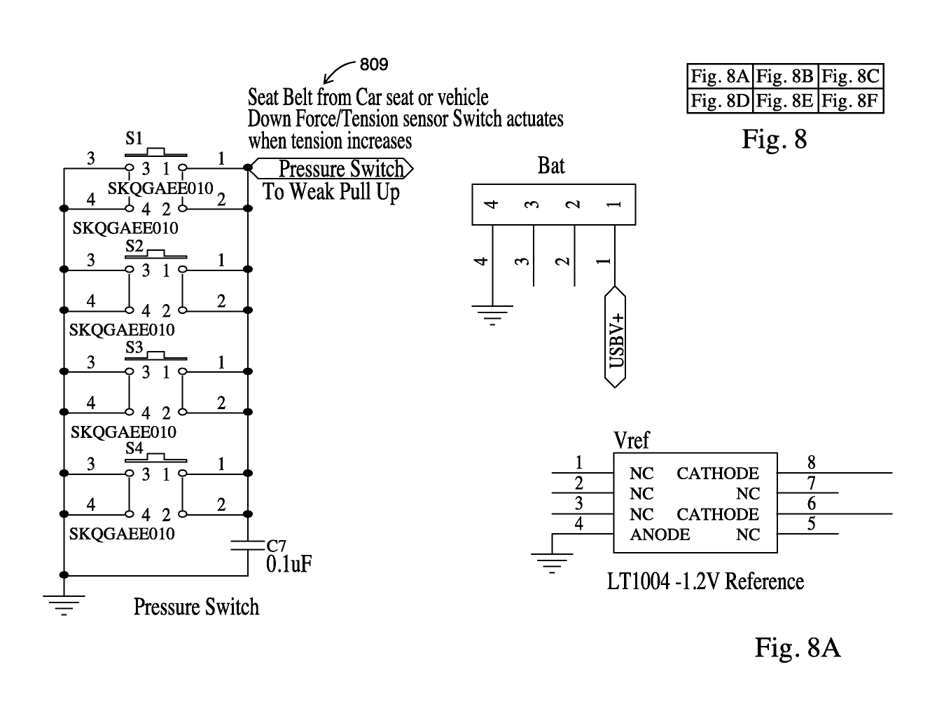

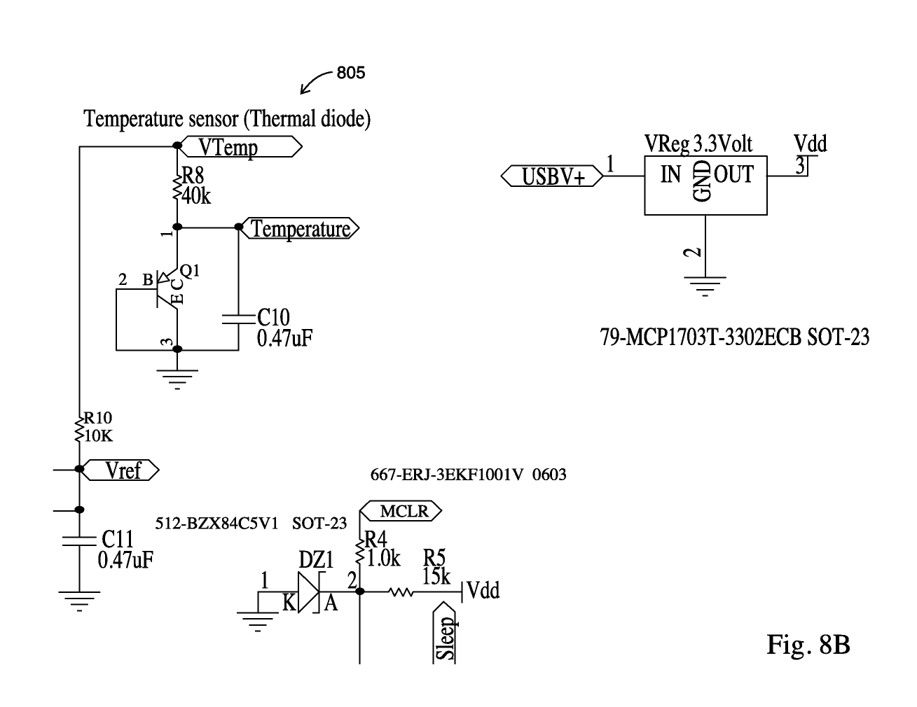

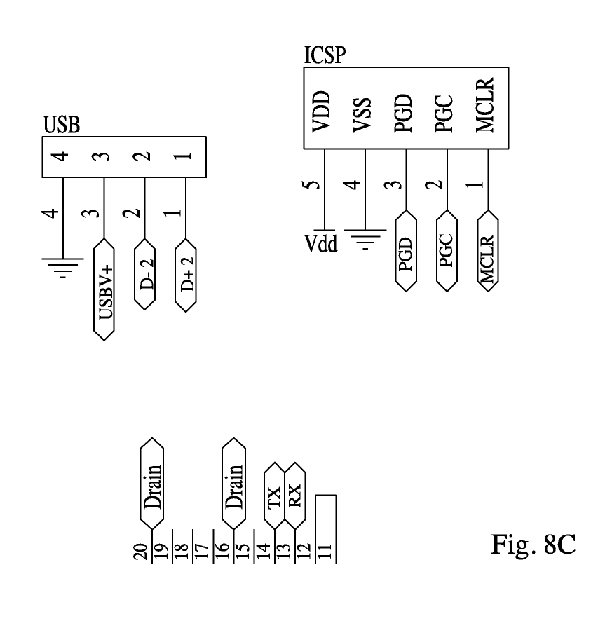

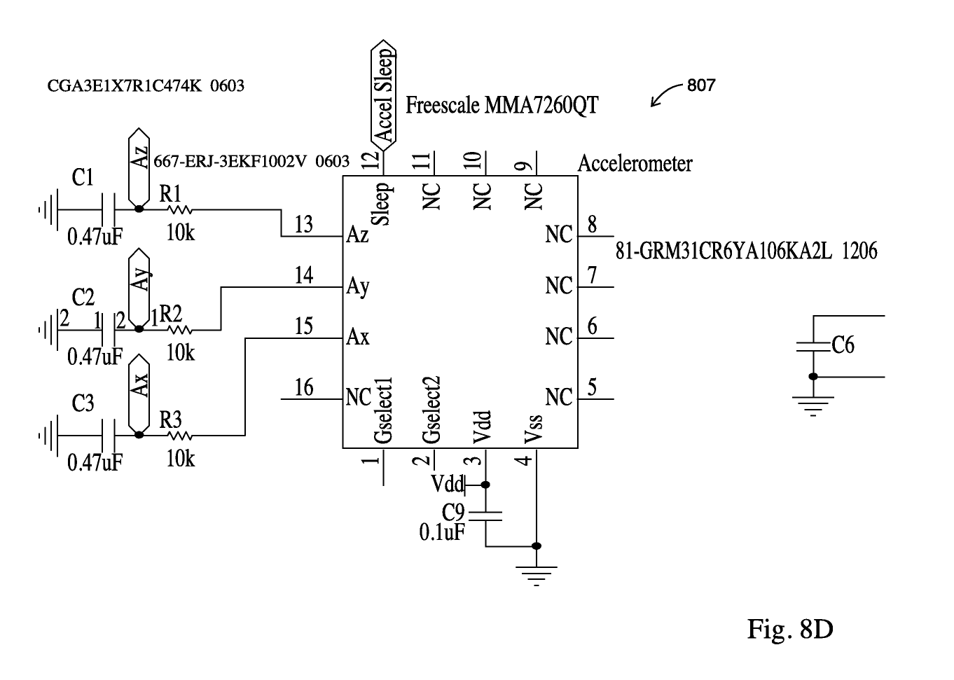

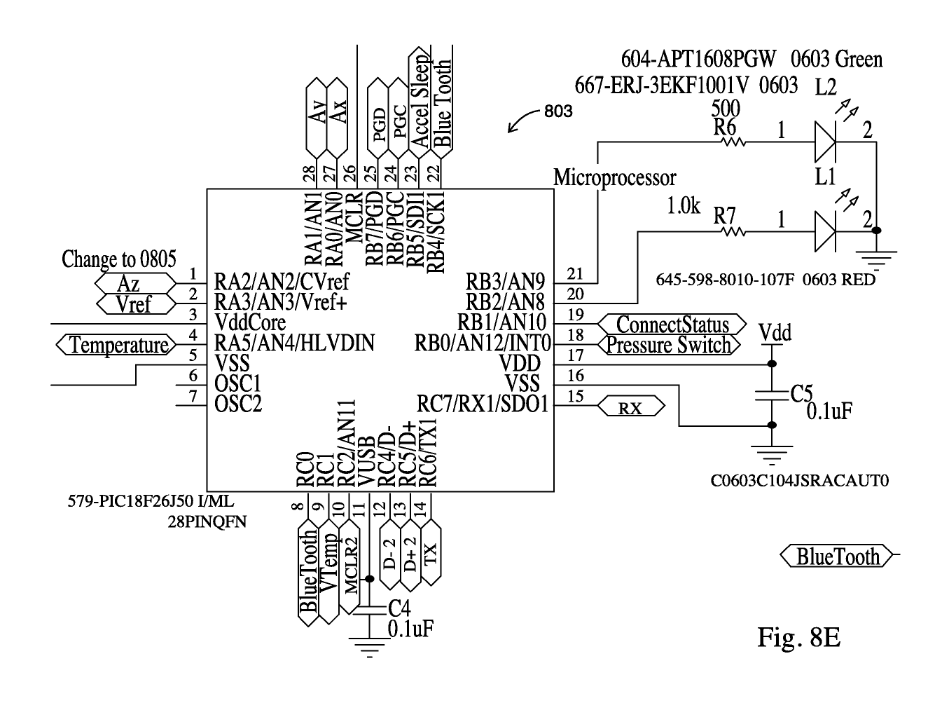

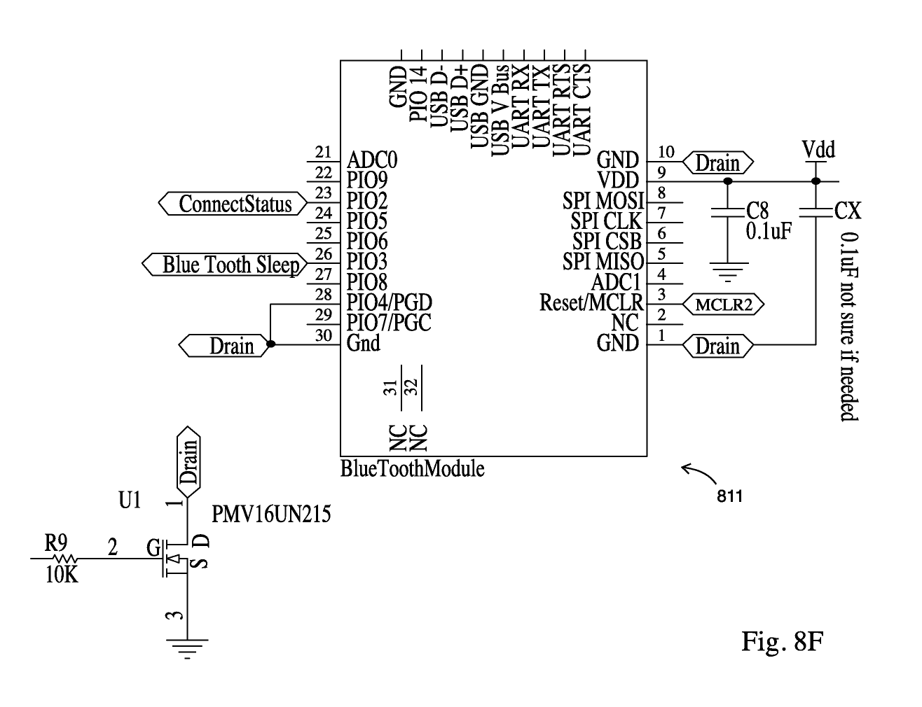

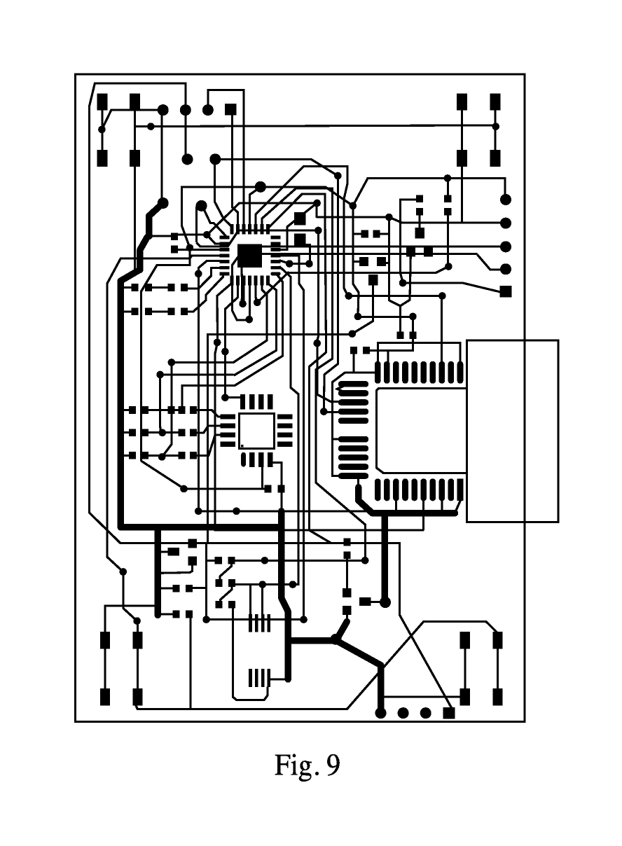

In the embodiment depicted in FIG. 2 and FIG. 8, the notification system is a BlueTooth® wireless transmitter (811). It is known in the art that wireless transmitters generally are also wireless receivers, and the term “transmitter” is understood to include both functions. BlueTooth® is a widely-adopted short-range wireless communication technology which is now commonly integrated into mobile devices, such as smart phones and tablet computers, as well as vehicle computer systems such but not limited to Ford Sync®, OnStar®, and AcuraLink™.

Other notification systems are specifically contemplated, including but not limited to other types of wireless transmitters (811), such as transmitters utilizing the 802.11 family of protocols, cellular, network, Internet, and infrared. Notification systems other than wireless transmitters (811) are also specifically contemplated, including but not limited to: an indicator light; an LED; a display screen; and, audible notification. Multiple notification means may be incorporated into an embodiment of these systems and methods.

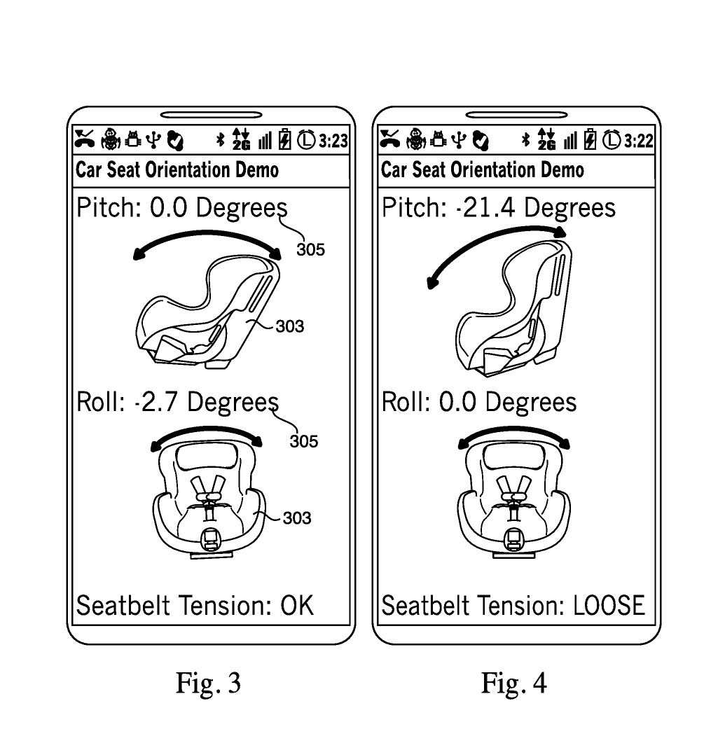

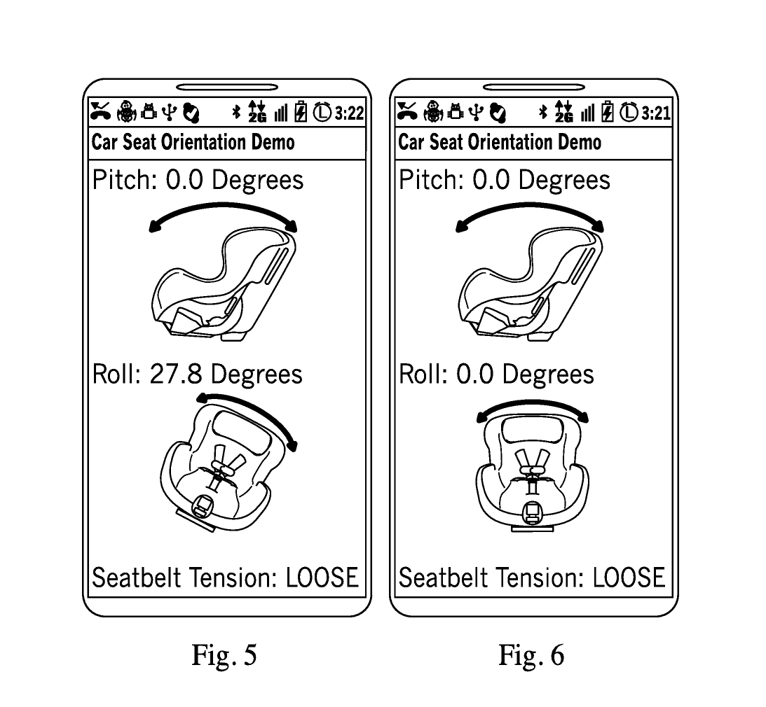

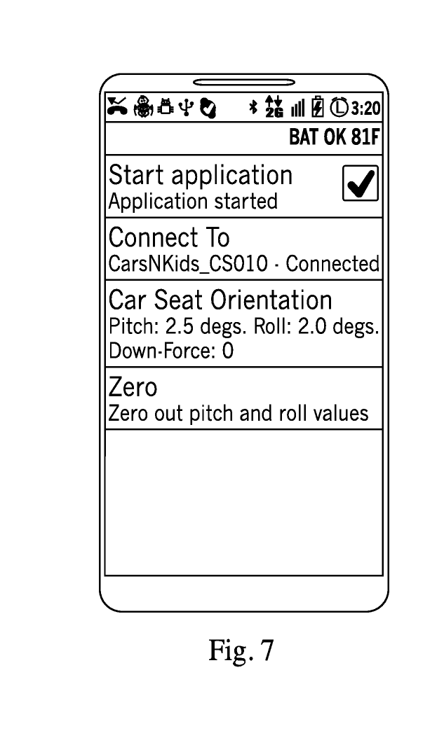

In an embodiment, the notification system provides data to a mobile device, such as smart phone like the Android® or iPhone® families of devices, or a tablet PC such as an iPad®. The mobile device may then provide information to the user based on the notification data, generally via an application with an interface which displays the notification data in user-friendly graphical format. FIGS. 3-7 depict embodiments of such an application on an Android® mobile device. As depicted in FIGS. 3-6, the application may include a representation (303) of a child seat (103) in graphical format, and may display a numeric representation (303) of the pitch (123) or roll (121). The representation (303) of a child seat (103) may be modified to convey the current pitch (123) or roll (121) of the child seat (103), such as by rotating the image, or altering the shading or coloring of the representation (303) to convey a dangerous condition. For example, when the car seat (103) is properly installed, a natural-color representation of the child seat (103) may be displayed; however, as the pitch (123) or roll (121) become more severe, the color shading of the representation (303) of the child seat (103) may become increasingly biased toward an alarming color, such as red, which the user is likely to notice.

The notifications may be received and/or displayed by a computer system integrated in, or added to, a vehicle. The specific mechanism for displaying notifications will necessarily vary from system to system, depending on the output capabilities of the system, user settings, standards for safe use of a computer system while in a vehicle, whether the vehicle is in motion when the notifications are conveyed, and other such considerations. By way of example and not limitation, notifications may be provided via: a dashboard light or other indicator; a warning light; an LCD or other display screen; a touchscreen display; a heads-up display system; an audible notification via the vehicle's audio system, such as by overriding the audio system controls to provide a notification. It is specifically contemplated that the conveyance of the notification may be proportional on, or otherwise depend upon, the severity of the information to be conveyed. By way of example and not limitation, a blinking red light and audible warning klaxon may be provided where the child has evacuated the child seat (103) or unclasped the child seat (103) belts (109) which restrain the child in the seat, but a static notification icon may be all that is displayed where the sun is in the child's eyes.

Because the monitor (201) is generally placed under the restraining belt (109) used to attach the child seat (103) to the vehicle, and because the precise location of this belt (109) necessary varies from child seat (103) to child seat (103), the angle of the monitor (201) will vary from child seat (103) to child seat (103). Additionally, there may be a range of orientations for a given child seat (103) which constitute a proper and safe installation. Also, a child seat (103) may have wildly differing orientations, even when installed correctly, depending on how the child seat (103) is installed. For example, a child seat (103) which is convertible from rear-facing mode to forward-facing, or vice versa, may have a very different pitch (121) angle depending on whether it is installed for rear-facing or forward-facing operation, and both angles may be considered a correct and safe installation for the installation type. Further, the correct orientation and angles for a given child seat (103) in a given mode may also differ from vehicle to vehicle, depending on the type of passenger seat the child seat (103) is attached to.

The orientation of the circuit board (202) with respect to the housing (204, 206) generally changes very little or not at all once the monitor (201) is assembled. Because the accelerometer (807) generally is affixed to the circuit board (202), its orientation also changes very little or not at all once the monitor (201) is assembled. Because the orientation of the housing (204, 205) is generally a function of where and how the monitor (201) is attached to the child seat (103), there may be circumstances in it is preferred that once the monitor (201) and child seat (103) are properly installed, the pitch (121) and roll (123) settings are “zeroed out.” That is, once the child seat (103) is properly installed in the vehicle with the monitor (201) in place, the z-axis (111) orientation detected by the accelerometer (807) is likely not vertical, or 0°. This functionality is similar to the concept of tare weight with a scale.

For example, in the embodiment depicted in FIG. 1, the monitor (201) is installed such that the top and bottom surfaces of the housing (204, 206) are not perpendicular to the z-axis (111) of the vehicle, and thus the z-axis (111) detected by the device (201) will not be 0°, but rather a relatively severe angle, such as 30° or 45°, even though the child seat (103) is properly installed in the vehicle. Using the “zero out” function, this angle value, regardless of what it is, will be treated as “zero,” and the pitch (123) and roll (121) angles will be reported as derived from this value.

For example, if the pitch (123) angle is 32.5° when the child seat (103) is properly installed, when the user elects to “zero out” the pitch (123) angle, 32.5° will be treated as 0°, or properly aligned. Thus, if the pitch (123) angle is later determined to be 30.0°, the car seat will be as reported out of alignment by −2.5°, because 32.5° is considered properly aligned. The function of storing the “zero out” angles and computing the pitch (123) and roll (121) angles from the “zero out” angles may be included in or performed by the accelerometer (807) itself, the microprocessor (803), other components of the monitor (201), or another component of the system. In an embodiment, this functionality is implemented in whole or party by an application, mobile device, vehicle, or a computer or server.

In the depicted embodiment, once the child seat (103) is properly installed, a user uses the “zero out” function to indicate that the orientation angles detected by the accelerometer (807) at that moment should be considered the angles at which the child seat (103) is correctly oriented, and pitch (123) and roll (121) angles should be calculated from those correct angles. In an embodiment, the correct angles are stored, and the differences between those correct angles and the angles detected by the accelerometer (807) at a point in time are used to determine whether the pitch (123) or roll (121) of the child seat (103) are misaligned. There are many means known in the art for implementing “tare” or “zero out” functionality, and any suitable means is contemplated. In an embodiment, the monitor (201) includes a button or other input means to indicate that the child seat (103) is properly installed and the present angles should be used as the “correct” angles for calculating misalignment.

In an embodiment, the system includes data regarding the proper orientation angles the device should detect when used in a particular child seat (103). This data may be provided by a child seat (103) manufacturer and preprogrammed or preloaded into a monitor (201), an application, a component system, or otherwise provided to or by the system. For example, a given child seat (103) manufacturer may have determined in advance what the x-, y-, and z-axes for the monitor (201) will be when the monitor (201) is installed in that manufacturer's child seat (103) and the child seat (103) is properly installed in a vehicle. These values may be included or provided so that the user need only notify the monitor (201) of the model of child seat (103) in which the monitor (201) is installed, and the monitor (201) already contains the proper “tare” or “zero out” values for the axes. In such an embodiment, the manual “zero out” process may be skipped.

In an embodiment, the monitor (201) is loaded with axes values corresponding with proper installation of a specific model of child seat (103) before, during, or after purchase. For example, a manufacturer, wholesaler, or retailer of the monitor (201) or a component system thereof may preload axes values before purchase. Also by way of example and not limitation, the retailer or consumer may load axes values after purchase. In an embodiment, axes values may be updated or supplemented. For example, when a new child seat (103) model is developed, or a more optimal angle for an existing child seat (103) is determined, those axes values may be altered or added to the monitor (201).

Although predetermined axes values functionality is described with reference to a monitor (201), this functionality may be implemented in other ways. By way of example and not limitation, in an embodiment, the predetermined axes value functionality is a feature of a mobile device application. In such an embodiment, the monitor (201) itself may have no logic or functionality for managing or utilizing predetermined axes values, and provides the actual axes values detected by the accelerometer (807) to the mobile device via the notification means (811). The mobile device then handles the functions of receiving and storing predetermined axes values for a particular child seat (103), indicating which child seat (103) the monitor (201) is presently installed in, and using the predetermined axes values for that child seat (103) model to calculate pitch (123) and roll (121).

Although predetermined axes value functionality is described with reference to the accelerometer (807) and axes of movement, predetermined values may also be used with other features of the systems and methods. By way of example and not limitation, the formulae and other data associated with translating depression of the pressure switch (207) into belt (109) tension may vary from car seat (103) to car seat (103), or from belt (109) to belt (109). This and other data particular to the car seat (103), belt (109), or other equipment used may be predetermined in similar fashion to the axes values as described herein, and provided to the systems and methods in similar fashion to the axes values as described herein.

Although predetermined values are described with reference to particular car seats (103), these values may also vary depending on the specific vehicle in which the child seat (103) is installed, or the specific area of the vehicle, such as in a captain's chair or a third-row bench. Predetermined values for axes, belt (109) tension, and other features of the systems and methods, may also be predetermined in similar fashion with respect to specific makes and models of vehicles, or specific seating locations within a given make and model of vehicle, and may be provided to the systems and methods in similar fashion to the predetermined axes values as described herein.

The systems and methods may also be provided with data which is not predetermined but which may be helpful or useful in improving the accuracy of calculations and determinations made. For example, the user may be able to provide the systems and methods with the age and/or weight of the child using the child seat (103).

The precise design of an application and the manner in which notification data is conveyed to the user will necessarily vary with platform, changing aesthetic tastes and interface design principles, and other considerations such as safety standards. By way of example and not limitation, the display in the application may be disabled, or not update, while the vehicle is in motion, and notifications may be provided only audibly.

The systems and methods may also use the notification system (811) to provide information which is not a notification, including but not limited to: whether a mobile device is connected with the monitor (201); how much time has passed since a mobile device last received a notification from the monitor (201); the remaining battery life of the monitor (201); diagnostic and/or operational data such as the monitor's (201) serial number, enabled features or functions, manufacture date, firmware or other software version, warnings, and errors.

In an embodiment, the systems and methods include a system (805) for detecting air temperature near the child seat (103). As depicted in FIG. 8, this system may be a temperature sensor (805) included in the circuit board (202). Child seats (103) are often used in the rear areas of minivans, and the air temperature in the rear portion of the vehicle may differ wildly from the air temperature near the driver's seat. Proper temperature control is critical to a child's health, particularly infants. The system for detecting air temperature (805) near the child seat (103) may be used to notify or warn the user that the child may be too hot or too cold. As with orientation and belt (109) tension, the temperature data may be provided via the notification system (811) and conveyed to the user, such as via a smart phone application, or an integrated notification system in the vehicle.

In an embodiment, the systems and methods include a system for detecting light or brightness (not depicted) near the child seat (103), and particularly near the child's eyes. Children often do not understand that they should not look directly into the sun, and the elevation of the child's eye line is often different from that of a driver. Thus, where the sun might be just below the treeline for the driver, if the child's eye line is slightly higher than the driver because of the size and shape of the child seat (103), the sunlight may nevertheless reach the child's eyes. The data obtained by the system for detecting brightness or light may be used to notify or warn the user that the child may be receiving direct sunlight. As with orientation and belt (109) tension, this data may be provided via the notification system (811) and conveyed to the user, such as via a smart phone application, or an integrated notification system in the vehicle.

In an embodiment, certain components systems depicted as connected to the microprocessor (803) via the circuit board (202), may instead be connected to the microprocessor (803) through other means, including but not limited to by wire or wireless connection. For example, the system for detecting temperature (808) and/or light (803) may be a remote wireless sensor placed on the front of a child seat (103), and the sensor may be connected to the microprocessor (803) via the BlueTooth® wireless transmitter.

It is known in the art that motion sensing devices can detect rhythmic moving patterns, such as breathing, and a number of infant breathing monitor are on the market. In an embodiment, the systems and methods include a system to detect whether a child in the child seat (103) to which the monitor (201) is attached is: asleep; awake; moving; chewing; eating; choking; still; breathing; not breathing; or, attempting to evacuate the child seat (103). In an embodiment, the systems and methods may include a system for determining whether the child or child seat (103) are soiled. By way of example and not limitation, the system for determining soiling may be a moisture sensor. Like the force transducer (809) and accelerometer (807), these component systems are generally managed and coordinated by the microprocessor (803), and notifications relating to the data may be provided via the notification system (811) as elsewhere described herein.

Although the systems and methods have been generally described with respect to a mobile device application, all systems and methods are described herein suitable for use with vehicle computer or notification systems, such as Ford Sync®, OnStar®, AcuraLink™, and other computer systems integrated into vehicles, or added onto vehicles. In the depicted embodiment, the monitor (201) can use the BlueTooth® transmitter (811) to provide data or notifications to a vehicle computer system. In an embodiment, the features and functions described herein with respect to a smart phone application notification means are implemented in whole or in part via a vehicle computer system.

Although the systems and methods have generally been described herein with respect to a monitor (201) attached to a child seat (103), a function or feature of the monitor (201) need not be implemented as a device separate from the child seat (103), but may be integrated into the child seat (103) itself. In an embodiment, a function or feature of the monitor (201) is integrated into a vehicle. By way of example and not limitation, a tension sensor may be integrated into a child seat (103).

In an embodiment, the systems and methods include a pressure sensor (119). This pressure sensor (119) may be located in the bottom of the child seat (103) as shown in FIG. 1. This pressure sensor (119) may be used to determine the presence of a child in the child seat (103), such as is contemplated by U.S. patent applications Ser. No.: 12/335,421 filed Dec. 15, 2008; 61/013,929 filed Dec. 14, 2007; 61/441,199 filed Feb. 9, 2011; 61/504,113 filed Jul. 1, 2011; and 61/538,647 filed Sep. 23, 2011. The entire disclosures of all such documents are incorporated herein by reference. In this embodiment, the pressure sensor (119) itself may include an accelerometer, which may act as an orientation sensor as well as a motion sensor, and which may be capable of determining whether the vehicle is moving or not moving, and whether the child is in the child seat (103). In an embodiment, the pressure sensor (119) and monitor (201) are connected. This connection may be made using any suitable means for linking such devices, including but not limited to a wireless connection, a serial bus connection via wire, or inclusion on a shared circuit board.

The proper orientation of a child's seat (103) in a vehicle may vary depending upon the age or weight of the child using the child seat (103). This is particularly true for child seats (103) designed for use with newborns and infants, whose size and weight tends to change rapidly. As the child increases in weight, the proper orientation of the child seat (103) in the car may change. In an embodiment of the present systems and methods, a pressure sensor (119) operates in conjunction with the monitor (201) to determine whether the child seat (103) orientation is proper for the child's current weight. Because the pressure sensor (119) is located beneath the area of where the child sits or rests in the child seat (103), the pressure sensor (119) may be able to obtain an approximation of the child's weight. Once this weight exceeds certain thresholds, the systems and methods may alert the user that the orientation is no longer correct. By way of example and not limitation, the pressure sensor (119) may provide this information to the monitor (201), which in turn may determine that the child seat (103) orientation is no longer proper for the child's current weight, and notify the user via the notification system (811).

In the depicted embodiment of FIG. 2, the top (206) and bottom (204) housings are configured to cooperate in a snap-together design. This coupling is loose enough that either the top (206) or bottom (204) housing may shift or move with the respect to the other component by about one millimeter (1 mm) in any direction. This flexibility allows the top (206) housing to distort downward when exposed to downward force (205) from the tension of the restraining belt (109), thus translating the force (205) exerted on the top housing (206) by the tension in the restraining belt (109) to the pressure switch (207) within the monitor (201). In the depicted embodiment, the pressure switch (207) is a tactile switch which depresses when the force (205) translated to it by the top housing (206) exceeds a certain threshold, the “break-over point” of the tactile switch (207). Other means for translating the tension of the belt (109) to the force transducer (809) may be used as well, including load cells. The housing (204, 206) is generally made of a rugged but flexible material which does not significantly inhibit wireless transmissions, such as plastic.

In the depicted embodiment, the circuit board (202) is enclosed within the housing (204, 206) when the device is assembled, and includes a microprocessor (803), accelerometer (807), wireless transmitter (811), and a force transducer (809). The circuit board (202) may also include other components, such as a temperature sensor (805). As discussed herein, the monitor (201) may also be connected wirelessly to other components not included on the circuit board (202), such as a remote light or moisture sensor. In an embodiment, one or more component systems are used to detect and measure downward force (205). In an embodiment, one or more component systems used to detect and measure downward force is separate from the circuit board (202) and is connected to the microprocessor (803) by wire or wirelessly.

In an embodiment, a component of the monitor (201) is integrated into the child seat (103). By way of example and not limitation, a force transducer (809) may be integrated into the child seat (103) structure to measure tension on other belts, or to measure proxies for tension on the restraining belt (109). In such an embodiment, the monitor (201) need not be in contact with the restraining belt (109), and may be located other than between the restraining belt (109) and the child seat (103) structure for easier access. In another embodiment, a pressure switch (207) or spring tension detector is integrated into the child seat (103) structure.

In an embodiment, the power source (203) is a battery. The battery (203) may be replaceable, rechargeable, or both. In an embodiment, the power source (203) is not completely enclosed within the housing (204, 206) when the monitor (201) is assembled. In another embodiment, the power source (203) is accessible through a removable hatch or cover in the housing (204, 206), preferably the bottom (204) housing, for easy replacement or recharging.

In an embodiment, the notification system (811) includes audible notifications. These notifications may be sounds, chimes, or other abstract audio cues, or may be spoken messages. In an embodiment with audible spoken messages, the messages may be prerecorded, or may be generated through artificial speech synthesis software or hardware. Audible notifications may be provided by the monitor (201) itself, such as through a speaker included in the monitor (201), or through an external mechanism, such as the audible output features of a mobile phone, tablet PC, or vehicle. These may include headphones, earbuds, wireless headsets, BlueTooth® headsets, or a vehicle's speakers. In an embodiment, an audible notification means is a telephone call.

In an embodiment, the notification system includes visual notifications. These notifications may be icons, images, messages, lights, or any other suitable form of visual notification. In an embodiment, the notification means includes text messages, e-mail messages, or other forms of network-based written messaging. The device through which the notification is provided to the user may be the vehicle or a component thereof, a device within the vehicle or a component thereof, or a device carried by the user or a component thereof. In an embodiment, notification may be provided to persons who are not in or near the vehicle. By way of example and not limitation, where the systems and methods are being used by a babysitter while the child's parents are not present, notifications may also be provided to a parent's mobile device. In an embodiment, notifications are conveyed via vehicular communications systems such as OnStar™ or Ford Sync™.

A feature of the systems and methods is that they provide continuous, real-time data to users without the user having to monitor indicators. For example, while a bubble level may be used to install a car seat (103) at the proper angle, the user cannot constantly monitor the bubble level while operating the vehicle. For one, the user should not remove his or her attention from the road. Moreover, the bubble in the level will naturally move and jostle as the vehicle traverses irregularities in the roadway, making it difficult for the user to obtain a reading, and the bubble level can only be accurately read while the vehicle is stopped. By contrast, the present systems and methods are capable of continuously monitoring the child seat (103) orientation and tension and can be designed and/or programmed to detect, ignore, and/or smooth out temporary irregularities, such as the vehicle being on a steep incline such as a parking garage ramp, bumpy roads, vehicle sway from a turn, or even energetic motion by the seated child.

In an embodiment, the systems and methods take continuous readings of each axis of orientation, or of best tension, over a period of time, calculates an average during that time period, and notifies the user of the average. By way of example and not limitation, the system may take twenty readings per second and provide notification of the average angle of each axis, or of best tension, over those twenty readings. In another embodiment, a rolling average may be used. Techniques for data smoothing and correcting irregularities are known in the art, and any suitable technique may be utilized.

In the depicted embodiment of FIG. 2, the monitor (201) includes a microprocessor (803). This microprocessor may be of any make or model, but will generally be a computer processor having a non-volatile memory suitable for storing software and other instructions, and a temporary memory, such as RAM, ROM, or EEPROM, suitable for recording and storing data, events, timestamps of events, and states of the monitor and/or application. Examples of such events include but are not limited to: incorrect belt tension; incorrect seat orientation; low battery life; child restraint harness unfastened; child evacuated from child seat (103) while vehicle in motion; uncomfortable or unsafe temperature or light warnings; soiling or moisture warnings; child movement and condition notifications; instructions from the user, such as “ignore” signals; and timestamps for these and other events.

The system for displaying or conveying notifications to the user may include systems other than a mobile device application or vehicle computer system. In an embodiment, notifications may be conveyed through an information display or other components of the monitor (201) or child seat (103), in lieu of or in addition to notifications sent to a mobile device. Such conveyance systems, when used a secondary notifications, may be useful for troubleshooting the systems or methods providing assurances to the user that the system is functioning normally.

The systems and methods may be used in conjunction with, or in lieu of, other systems for determining the orientation of a child seat (203). For example, modern child seats may include a rolling ball in a curved, transparent container affixed to the child seat. This ball aligns with certain graduation marks and colors in the background of the container as the pitch of the seat changes, to give the user an indication that the pitch of the seat is correct. This rolling ball system may be replaced with an embodiment of the systems and methods discussed herein, including but not limited to an electronic display, such as an LEDs or set of LEDs, whether or the same or differing colors, which provide an indication to the user of whether the child seat (103) is properly oriented. In another embodiment, the indication may be provided by an LCD screen or audible alert.

In an embodiment, the systems and methods described herein may be used to detect or monitor tension of the safety restraint harness used to restrain the child in the child seat (103). Modern child seats (103) typically include at least a three-point, and often a five-point harness system. These systems include two shoulder straps coupled near the child's groin to a third strap laced through a hole in the base of the child seat (103) and then laced through a friction-based adjustment system, with the slack in the strap laying flat against the front of the child seat (103) between the child's legs. By disengaging the lock in the adjustment system and pulling on the protruding slack of the third strap, the overall tension of the shoulder straps is increased. The user then re-engages the adjustment lock to prevent the tension from loosening. In an embodiment, a monitor (201) or component system thereof is placed between the adjustment belt and the seat (103) structure to detect, measure, and/or notify the user of the safety restraint harness tension.

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

1. A child seat orientation monitor comprising:
a housing;
an orientation detector within said housing;
a force transducer within said housing;
wherein force exerted on said housing is translated to said force transducer;
wherein when said monitor is attached to a child seat installed in a vehicle, said orientation detector determines the orientation of said child seat and said force transducer determines the tension of a belt attaching said child seat to said vehicle.

2. The monitor of claim 1, wherein said orientation detector is a three-axis accelerometer.

3. The monitor of claim 1, said monitor further comprising:
a wireless transmitter within said housing transmitting data about said orientation and said tension.

4. The monitor of claim 3, wherein a mobile device receives and displays said data.

5. The monitor of claim 4, wherein said mobile device is a mobile phone.

6. The monitor of claim 4, wherein said mobile device is a tablet computer.

7. The monitor of claim 3, wherein a vehicle computer system receives and displays said data.

8. The monitor of claim 3, wherein said wireless transmitter uses a BlueTooth protocol.

9. The monitor of claim 1, said monitor further comprising:
a temperature sensor within said housing determining the air temperature near said child seat.

10. A system for providing notifications about the installation of a child seat in a vehicle, said system comprising:
an orientation detector attached to a child seat for detecting the orientation of said child seat in a vehicle;
a force transducer attached to said child seat for detecting the tension of a belt attaching said child seat to said vehicle;
a wireless transmitter transmitting data about said orientation and said tension;
a wireless receiver receiving said data; and
a display for conveying said data transmitted by said wireless transmitter and received by said wireless receiver to a user.

11. The system of claim 10, wherein said wireless transmitter uses a BlueTooth protocol.

12. The system of claim 10, wherein said orientation detector is a three-axis accelerometer.

13. The system of claim 10, wherein said display is a mobile phone.

14. The system of claim 10, wherein said display is a vehicle computer system.

15. The system of claim 10, further comprising:
a temperature sensor detecting the air temperature near said child seat;
wherein said wireless transmitter transmits data about said air temperature, said wireless receiver receives said data, and said display conveys said data to a user.

16. A method for providing notifications about the installation of a child seat in a vehicle, said method comprising:
providing a child seat orientation monitor including:
an orientation detector;
a force transducer;
a wireless transmitter;
providing a display separate from said orientation monitor and configured to receive transmissions from said wireless transmitter;
providing a child seat;
providing a vehicle;
installing said orientation monitor in said child seat;
installing said child seat in said vehicle with a belt;
said orientation monitor detecting the orientation of said child seat in said vehicle with said orientation detector;
said orientation monitor detecting the tension of said belt with said force transducer;
said orientation monitor transmitting data about said orientation and said tension to said display with said wireless transmitter;
said display providing a notification of said orientation and said tension to a user.

17. The method of claim 16, wherein said orientation detector is a three-axis accelerometer.

18. The method of claim 16, wherein said display is a mobile phone.

19. The method of claim 16, wherein said display is a vehicle computer system.

20. The method of claim 16, further comprising:
in the providing, said child seat orientation monitor further comprising a temperature sensor;
said orientation monitor detecting the air temperature near said child seat with said temperature sensor;
said orientation monitor transmitting data about said air temperature to said display with said wireless transmitter;
said display providing a notification of said air temperature to a user.
